(19) United States
(12) Patent Application Publication
(10) Pub. No.: US 2024/0190387 A1
(43) Pub. Date: Jun. 13, 2024

(54) Vehicle Security System

(71) Applicants: Peter Pipicelli, Vero Beach, FL (US); Marta Bertoldo, Vero Beach, FL (US)

(72) Inventors: Peter Pipicelli, Vero Beach, FL (US); Marta Bertoldo, Vero Beach, FL (US)

(21) Appl. No.: 18/517,159

(22) Filed: Nov. 22, 2023

Related U.S. Application Data
(60) Provisional application No. 63/430,884, filed on Dec. 7, 2022.

(51) Int. Cl. B60R 25/30; B60R 25/102

(52) U.S. Cl. CPC B60R 25/305; B60R 25/102; G07C 5/02

(57) ABSTRACT

The present invention relates to a vehicle security system that allows a user to monitor their vehicle when not in said vehicle. The system uses at least one camera and at least one sensor to allow a user to monitor a vehicle via a mobile application. Photos/videos taken from the camera can be stored on a cloud database. In addition, the mobile application alerts the user if suspicious individuals are around their vehicle and/or if their vehicle has been broken into.

### CROSS-REFERENCE TO RELATED APPLICATION

The present application claims priority to, and the benefit of, U.S. Provisional Application No. 63/430,884, which was filed on Dec. 7, 2022, and is incorporated herein by reference in its entirety.

### FIELD OF THE INVENTION

The present invention relates generally to the field of vehicle security systems. More specifically, the present invention relates to a vehicle security system. The system uses at least one camera and at least one sensor to allow a user to monitor a vehicle via a mobile application, in addition to storing photos and videos from the camera to a cloud database as well as alerting a user to a vehicle break-in. Accordingly, the present disclosure makes specific reference thereto. Nonetheless, it is to be appreciated that aspects of the present invention are also equally applicable to other like applications, devices, and methods of manufacture.

### BACKGROUND

Vehicle vandalism and break-ins are unfortunately extremely common. However, many vehicle owners may be unable to record who broke into their vehicle. As a result, the vehicle owner will be left guessing as to who damaged and stole items from their vehicle. In addition, existing vehicles with outward-facing cameras lack customizability.

Therefore, there exists a long-felt need in the art for an improved vehicle security system. More specifically, there exists a long-felt need in the art for a vehicle security system that allows a user to comprehensively monitor their vehicle. There also exists a long-felt need in the art for a vehicle security system that notifies an owner if an individual is near their vehicle. In addition, there exists a long-felt need in the art for a vehicle security system that notifies an owner if their vehicle is broken into. Further, there exists a long-felt need in the art for a vehicle security system that can be retrofitted to a vehicle and that can be used with the existing cameras and sensors of a vehicle. Finally, there exists a long-felt need in the art for a vehicle security system that can be customized by the user regarding when and what safety measures are used to secure the vehicle.

In this manner, the vehicle security system of the present invention accomplishes all the foregoing objectives and provides an improved vehicle security system that allows a user to comprehensively monitor their vehicle by notifying a user if an individual is near their vehicle and/or their vehicle has been broken into via the mobile application. Further, the system can be retrofitted to a vehicle and can also be used with the existing cameras and sensors of a vehicle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle security system primarily comprised of a mobile application, a sensor, and a cloud database. The system allows a user to control the functions of a vehicle in addition to allowing a user to view individuals near the vehicle via a camera. The system is comprised of at least one sensor. The sensor may be any type of sensor found within an existing vehicle from factory manufacture or may be an aftermarket component that a user can install within and/or on the vehicle via any means known in the art, such as mounting, screwing, or using any fastener type known in the art.

In one embodiment, the sensor is a motion sensor that may be positioned on the inside or the outside of the vehicle. The sensor is in wireless electrical communication with the mobile application of the system and detects any motion within a threshold distance such as, but not limited to, three feet from the vehicle. In another embodiment, the sensor is a glass-break sensor (of any type of glass-break sensor known in the art). In this embodiment, the sensor may be positioned on the inside or the outside of the vehicle and is in wireless electrical communication with the mobile application of the system. The sensor detects when a window of the vehicle is broken and/or damaged (i.e., cracked).

In one embodiment, the system may also have at least one camera positioned on the inside or the outside of the vehicle. The camera allows a user to observe the conditions around and/or within the vehicle via the mobile application in real time or via recorded video playback. The camera may livestream video and may also capture recorded videos/photos that can be stored and uploaded to a cloud database. In one embodiment, the camera may begin recording/streaming a video and/or taking a photo if the sensor detects motion within a threshold distance and/or detects a window of the vehicle breaking or becoming damaged.

The mobile application has a plurality of functions that allow the user to use the system. For example, the mobile application allows a user to control the camera to view a live stream video from the camera, view recorded videos/photos from the camera, take a photo from the camera, etc. Similarly, the application allows a user to save photos, videos, recordings, etc., from the camera to the cloud database for later viewing.

In addition, the mobile application may notify a user if their vehicle is or is about to be broken into via at least one alert. In this embodiment, the mobile application receives input from the sensor. More specifically, the mobile application may receive input if the sensor detects motion within a threshold distance and/or detects that a window of the vehicle has been broken or damaged. Once detected, the mobile application may alert a user via an alert such as, but not limited to, a notification, a text message, an email, a phone call, etc.

The present invention is also comprised of a method of using the system. First, a system is provided comprised of a mobile application, a sensor, and a cloud database. Then, a user can use the mobile application to monitor the interior and/or area around a vehicle the system is used with via video that can be stored in the cloud database. In addition, the mobile application may allow a user to create a pre-set configuration for the sensor and/or a camera of the system.

Accordingly, the vehicle security system of the present invention is particularly advantageous as it provides an improved vehicle security system that allows a user to comprehensively monitor their vehicle by notifying a user via the mobile application if an individual is near their vehicle and/or their vehicle has been broken into. Further, the system can be retrofitted to a vehicle and can also be used with the existing cameras and sensors of a vehicle. In this manner, the vehicle security system provides an improved system for ensuring vehicle security.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of one potential embodiment of a vehicle security system of the present invention in accordance with the disclosed architecture;

FIG. 2 illustrates a graphical view of a mobile application of one potential embodiment of a vehicle security system of the present invention in accordance with the disclosed architecture;

FIG. 3 illustrates a graphical view of a camera and a sensor of one potential embodiment of a vehicle security system of the present invention in accordance with the disclosed architecture; and

FIG. 4 illustrates a flowchart of a method of using one potential embodiment of a vehicle security system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vehicle security system. More specifically, there exists a long-felt need in the art for a vehicle security system that allows a user to comprehensively monitor their vehicle. There also exists a long-felt need in the art for a vehicle security system that notifies an owner if an individual is near their vehicle. In addition, there exists a long-felt need in the art for a vehicle security system that notifies an owner if their vehicle is broken into. Further, there exists a long-felt need in the art for a vehicle security system that can be retrofitted to a vehicle and that can be used with the existing cameras and sensors of a vehicle. Finally, there exists a long-felt need in the art for a vehicle security system that can be customized by the user regarding when and what safety measures are used to secure the vehicle.

The present invention, in one exemplary embodiment, is comprised of a vehicle security system. The system is primarily comprised of a mobile application, a sensor, and a cloud database. The system allows a user to control the functions of a vehicle in addition to allowing a user to view individuals near the vehicle via a camera. The system is comprised of at least one sensor of any type of sensor found within an existing vehicle from factory manufacture or aftermarket component that a user can install within and/or on the vehicle via any means known in the art such as mounting, screwing, or using any fastener type known in the art.

In one embodiment, the sensor is a motion sensor that may be positioned on the inside or the outside of the vehicle. The sensor is in wireless electrical communication with the mobile application of the system and detects any motion within a threshold distance such as, but not limited to, three feet from the vehicle. The sensor may also be a glass-break sensor (of any type of glass-break sensor known in the art). In this embodiment, the sensor may be positioned on the inside or the outside of the vehicle and is in wireless electrical communication with the mobile application of the system. The sensor detects when a window of the vehicle is broken and/or damaged (i.e., cracked).

In one embodiment, the system may also have at least one camera positioned on the inside or the outside of the vehicle that allows a user to observe the conditions around and/or within the vehicle via the mobile application in real time or via recorded video playback. The camera may livestream video and may also capture recorded videos/photos that can be stored and uploaded to a cloud database. In one embodiment, the camera may begin recording/streaming a video and/or taking a photo if the sensor detects motion within a threshold distance and/or detects a window of the vehicle breaking or becoming damaged.

The mobile application has a plurality of functions that allow the user to use the system.

For example, the mobile application allows a user to control the camera to view a live stream video from the camera, view recorded videos/photos from the camera, take a photo from the camera, etc. Similarly, the application allows a user to save photos, videos, recordings, etc., from the camera to the cloud database for later viewing.

The mobile application may also notify a user if their vehicle is or is about to be broken into via at least one alert. In this embodiment, the mobile application receives input from the sensor. More specifically, the mobile application may receive input if the sensor detects motion within a threshold distance and/or detects that a window of the vehicle has been broken or damaged. Once detected, the mobile application may alert a user via an alert such as, but not limited to, a notification, a text message, an email, a phone call, etc.

The present invention is also comprised of a method of using the system. First, a system is provided comprised of a mobile application, a sensor, and a cloud database. Then, a user can use the mobile application to monitor the interior and/or area around a vehicle the system is used with via video that can be stored in the cloud database. In addition, the mobile application may allow a user to create a pre-set configuration for the sensor and/or a camera of the system.

Accordingly, the vehicle security system of the present invention is particularly advantageous as it provides an improved vehicle security system that allows a user to comprehensively monitor their vehicle by notifying a user via the mobile application if an individual is near their vehicle and/or their vehicle has been broken into. Further, the system can be retrofitted to a vehicle and can also be used with the existing cameras and sensors of a vehicle. In this manner, the vehicle security system provides an improved system for ensuring vehicle security.

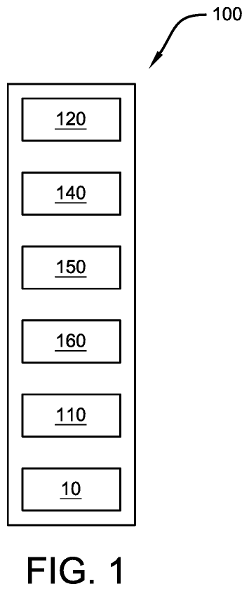

Referring initially to the drawings, FIG. 1 illustrates a graphical view of one potential embodiment of a vehicle security system 100 of the present invention in accordance with the disclosed architecture. The system 100 is primarily comprised of a mobile application 120, a sensor 150, and a cloud database 160. The system 100 allows a user to control functions of a vehicle 10 in addition to allowing a user to view individuals near the vehicle 10 via a camera 140.

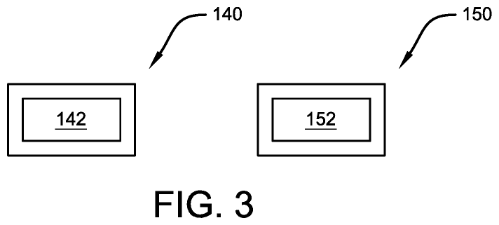

The system 100 is comprised of at least one sensor 150, as seen in FIG. 3. In one embodiment, the sensor 150 may be any type of sensor found within an existing vehicle 10 from factory manufacture. In another embodiment, the sensor 150 is an aftermarket component that a user can install within and/or on the vehicle 10 via any means known in the art, such as mounting, screwing, or using any fastener type known in the art. The sensor 150 may be a plurality of sensor types in different embodiments.

In one embodiment, the sensor 150 is a motion sensor (of any type of motion sensor known in the art). In this embodiment, the sensor 150 may be positioned on the inside or the outside of the vehicle 10. The sensor 150 is in wireless electrical communication with the mobile application 120 of the system 100 via a Wi-Fi, Bluetooth, Cellular, etc., transmitter 152. The sensor 150 detects any motion within a threshold distance such as, but not limited to, three feet from the vehicle.

In another embodiment, the sensor 150 is a glass-break sensor (of any type of glass- break sensor known in the art). In this embodiment, the sensor 150 may be positioned on the inside or the outside of the vehicle 10 (including the inside/outside of a window of the vehicle 10). The sensor 150 is in wireless electrical communication with the mobile application 120 of the system 100 via a Wi-Fi, Bluetooth, Cellular, etc., transmitter 152. The sensor 150 detects when a window of the vehicle 10 is broken and/or damaged (i.e., cracked).

In one embodiment, the system 100 may also have at least one camera 140, as seen in FIG. 3. The camera 140 may be any type of camera known in the art. The camera 140 may be positioned on the inside or the outside of the vehicle 10. The camera 140 allows a user to observe the conditions around and/or within the vehicle 10 via the mobile application 120 in real-time or via recorded video playback. The camera 140 also detects, monitors, and identifies objects and/or locations around the vehicle 10.

The camera 140 is in wireless electrical communication with the mobile application 120 of the system 100 via a Wi-Fi, Bluetooth, Cellular, etc., transmitter 142. The camera 140 may livestream video and may also capture recorded video/photos that can be stored and uploaded to a cloud database 160. In one embodiment, the camera 140 may begin recording/streaming a video and/or taking a photo if the sensor 150 detects motion within a threshold distance and/or detects a window of the vehicle 10 breaking or becoming damaged.

The mobile application 120 may be in the form of a mobile app and/or software. The mobile application 120 can be used on a smart device 110 such as, but not limited to, a computer, a smartphone, a tablet, etc.

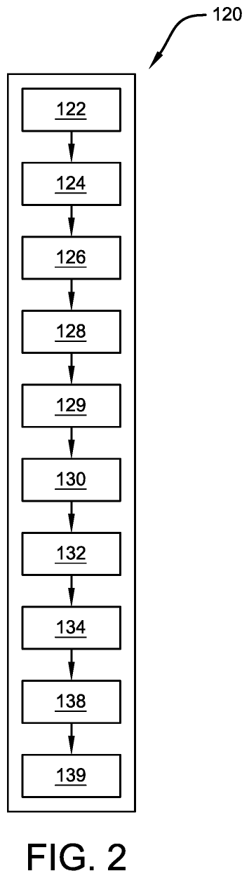

The mobile application 120 has a plurality of functions that allow the user to use the system 100, as seen in FIG. 2. First, the mobile application 120 allows a user to control the camera 140 [122] of the system 100. This function allows a user to view a live stream video from the camera 140, view recorded videos/photos from the camera 140, take a photo from the camera 140, etc. Similarly, the application 120 allows a user to save photos, video, recordings, etc., from the camera 140 to the cloud database 160 for later viewing [124]. In addition, the recordings can be downloaded from the cloud database to an external device such as but not limited to a hardware or flash drive. The cloud database 160 allows a user to download said recordings whether the vehicle 10 is on or off. The application 120 may also allow a user to record travel information [126]. Said information includes, but is not limited to, recording vehicle parking location, recording vehicle condition, etc.

In one embodiment, the system 100, and more specifically the mobile application 120, is in wireless electrical communication with the vehicle 10 itself (i.e., the existing computer systems of the vehicle from manufacture). In this embodiment, the mobile application 120 allows a user to control functions of the vehicle [128]. Said functions include, but are not limited to, locking/unlocking the vehicle 10, turning the vehicle 10 on/off, turning the vehicle 10 alarm on/off, preventing the vehicle 10 from driving, etc. In addition, this embodiment may receive any alert from the vehicle 10, ex. a low tire alert, an engine alert, etc. The mobile application 120 can also wirelessly connect with any GPS or other technology of the like.

In addition, the mobile application 120 may notify [129] a user if their vehicle is or is about to be broken into via at least one alert. In this embodiment, the mobile application 120 receives input from the sensor 150. More specifically, the mobile application 120 may receive input if the sensor 150 detects motion within a threshold distance and/or detects that a window of the vehicle 10 has been broken or damaged. Once detected, the mobile application 120 may alert a user via an alert such as, but not limited to, a notification, a text message, an email, a phone call, etc.

In addition, the mobile application 120 may allow a user to create pre-set configurations

for any of the functions and processes described supra. One of said configurations [130] may allow a user to configure the camera 140 to continuously record during specific time periods of day, such as, but not limited to, when a user is at work and their vehicle is left unattended for a long period of time.

In one embodiment, the application 120 is comprised of at least one security feature 132 that protects access to the application 120. Said feature 132 includes but is not limited to an

ID and passcode, multi-step verification, encryption key codes, etc. The application 120 may also allow a user to alert individuals 134 using the application 120 via a call, a text, an email, an alert, etc. Said individuals 134 may include but are not limited to police, fire, EMS, or other secondary individuals. The application 120 may also work as a key fob 136 for the vehicle 10, retaining any function of the physical vehicle 10 key fob. The application 120 may also allow a user to view the GPS location of the vehicle 138 on a map interface. Information/data from the system 100 can further be uploaded 139 remotely to the application 120 or physically to the smart device 100 via wired data transfer between the device 110 and vehicle 10.

It should be appreciated that the system 100 may work with any existing camera 140 and/or sensor 150 found on any existing vehicle 10 known in the art, which includes but is not limited to all autonomous, semi-autonomous, and non-automated vehicles.

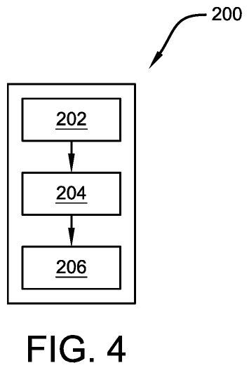

The present invention is also comprised of a method of using the system 100, as seen in FIG. 4. First, a system 100 is provided comprised of a mobile application 120, a sensor 150, a camera 140, and a cloud database 160 [Step 202]. Then, a user can use the mobile application 120 to monitor the interior and/or area around a vehicle 10 the system 100 is used with via video from the camera 140 that can be stored in the cloud database 160 and/or an input from the sensor 150 [Step 204]. In addition, the mobile application 120 may allow a user to create a pre-set configuration [130] for the sensor 150 and/or a camera 140 of the system 100 [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle security system” and “system” are interchangeable and refer to the vehicle security system 100 of the present invention.

Notwithstanding the foregoing, the vehicle security system 100 of the present invention and its various components can be of any suitable size and configuration as is known in the art without affecting the overall concept of the invention, provided that they accomplish the above- stated objectives. One of ordinary skill in the art will appreciate that the size, configuration, and material of the vehicle security system 100 as shown in the FIGS. are for illustrative purposes only, and that many other sizes and shapes of the vehicle security system 100 are well within the scope of the present disclosure. Although the dimensions of the vehicle security system 100 are important design parameters for user convenience, the vehicle security system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle security system comprising:
a mobile application;
a sensor;
a camera; and
a cloud database.

2. The vehicle security system of claim 1, wherein the sensor is comprised of a motion sensor.

3. The vehicle security system of claim 2, wherein the sensor is comprised of a threshold distance.

4. The vehicle security system of claim 1, wherein the camera is in wireless electrical communication with the mobile application.

5. The vehicle security system of claim 1, wherein the sensor is in wireless electrical communication with the mobile application.

6. The vehicle security system of claim 1, wherein the sensor is comprised of a glass-break sensor.

7. A vehicle security system comprising:
a vehicle;
a mobile application;
a sensor;
a camera; and
a cloud database.

8. The vehicle security system of claim 7, wherein the mobile application controls a function of the vehicle.

9. The vehicle security system of claim 7, wherein the mobile application records a travel information of the vehicle.

10. The vehicle security system of claim 7, wherein the mobile application controls a function of the camera.

11. The vehicle security system of claim 7, wherein the camera records a video that is stored on the cloud database.

12. The vehicle security system of claim 7, wherein the camera records a video that is live streamed to the mobile application.

13. The vehicle security system of claim 7, wherein the mobile application creates an alert.

14. The vehicle security system of claim 13, wherein the alert is created when the sensor detects motion within a threshold distance.

15. The vehicle security system of claim 13, wherein the camera records a video when motion is detected within the threshold distance by the sensor.

16. The vehicle security system of claim 7, wherein the camera records a video when the sensor detects motion within a threshold distance.

17. The vehicle security system of claim 13, wherein the alert is created when the sensor detects a glass-break.

18. A method of using a vehicle security system, the method comprising the steps of:
providing a vehicle security system comprised of a mobile application, a sensor, camera, and a cloud database;
using the mobile application to monitor a vehicle via a video from the camera and an input from the sensor; and
storing the video in a cloud database.

19. The method of claim 18, wherein the vehicle security system alerts a user if the sensor detects movement.

20. The method of claim 18, wherein the vehicle security system produces an alert.
